(19) United States
(12) Patent Application Publication
(10) Pub. No.: US 2009/0294998 A1
(43) Pub. Date: Dec. 3, 2009

(54) Method and Apparatus for Producing Embossed Sheet

(75) Inventors: Shotaro Ogawa, Fujinomiya-shi (JP); Ryuichi Katsumoto, Fujinomiya-Shi (JP); Makoto Koike, Fujinomiya-Shi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 11/992,422

(22) PCT Filed: Sep. 21, 2006
(86) PCT No.: PCT/JP2006/319218

§ 371 Date: Aug. 10, 2009

(30) Foreign Application Priority Data
Sep. 22, 2005 (JP) 2005-276715
Oct. 14, 2005 (JP) 2005-300454
Oct. 28, 2005 (JP) 2005-314935

(51) Int. Cl. B29D 11/00; B29C 59/16; B28B 19/00

(52) U.S. Cl. 264/1.6; 264/447; 264/284; 156/390

(57) ABSTRACT

A method of producing an embossed sheet includes the steps of allowing a flexible strip-shaped sheet to continuously travel, forming a coating layer by coating the surface of the sheet with a radiation curable resin, transferring a pattern of concavities and convexities on the surface of the emboss roller to the coating layer by winding the sheet around the rotating emboss roller, curing the coating layer by irradiating the sheet which is wound around the roller with radiation, releasing the sheet from the emboss roller, laminating a protective film on one or both sides of the continuously traveling sheet after releasing, and taking up the continuously traveling sheet after lamination in the form of a roll. According to the method, a high quality, defect-free embossed sheet having a fine regular pattern of concavities and convexities on the surface can be produced at high line speed with high productivity.

### TECHNICAL FIELD

The present invention relates to a method and an apparatus for producing an embossed sheet, more specifically, to a method and an apparatus for producing an embossed sheet which are suitable for producing a high quality, defect-free sheet-like material such as an emboss sheet having a fine regular pattern of concavities and convexities on the surface and having an antireflection effect with high productivity or at high line speed with high productivity.

### BACKGROUND ART

Recently, emboss sheets having an antireflection effect have been used for electronic displays such as liquid crystal displays. Also, flat lenses such as lenticular lenses and fly-eye lenses and emboss sheets such as light diffusion sheets, brightness improving sheets, optical waveguide sheets and prism sheets have been used. Sheets having a fine regular pattern of concavities and convexities on the surface are known as such an emboss sheet. Various methods have been conventionally known as a technique for forming such fine regular patterns of concavities and convexities (see Japanese Patent Application Laid-Open Nos. 11-262958, 11-300768, 2001-314815, 2002-67057 and 2002-365405, Japanese Patent Nos. 2533379 and 2891344, Japanese Patent Application Laid-Open Nos. 2000-141481 and 2005-53039).

For example, these publications disclose that in an apparatus having a configuration as shown in FIG. 4, a resin is applied to the surface of a stamper roller 1 on which a regular pattern of concavities and convexities is formed by a coating means 2; a continuously traveling sheet 3 is sandwiched between the stamper roller 1 and a nip roller 4; the resin is cured by irradiation of ionization radiation with the resin on the stamper roller 1 being brought into contact with the sheet 3; and then the sheet 3 is released from the stamper roller 1 by winding it around a release roller 5.

These publications also disclose that in an apparatus having a configuration as shown in FIG. 5, a resin is previously applied to the surface of a continuously traveling sheet 3; the resin is cured by irradiation of ionization radiation with the sheet 3 being sandwiched between a stamper roller 1 on which a regular pattern of concavities and convexities is formed and a nip roller 4 and the pattern of concavities and convexities on the stamper roller 1 being transferred to the resin; and then the sheet 3 is released from the stamper roller 1 by winding it around a release roller 5.

However, the above-mentioned Japanese Patent Application Laid-Open Nos. 11-262958, 11-300768, 2001-314815, 2002-67057 and 2002-365405 related to such production line of an emboss sheet disclose only a basic structure, not the entire production line. Therefore, it is very difficult to produce a high quality, defect-free embossed sheet having a fine regular pattern of concavities and convexities on the surface at high line speed with high productivity only from the disclosure in Japanese Patent Application Laid-Open Nos. 11-262958, 11-300768, 2001-314815, 2002-67057 and 2002-365405.

Moreover, if the continuously traveling sheet 3 and the stamper roller 1 have a different rate in an apparatus of such a configuration, slipping occurs between the sheet and the roller, causing a problem that the regular pattern of concavities and convexities on the surface of the roller cannot be exactly transferred to or formed on the sheet.

In short, the key point in such processes is that the difference in the rate of the continuously traveling sheet 3 and the rotating roller 1 (emboss roller) is zero on the roller. In particular, obviously no slipping should occur even on the order of μm in the case of a pattern of concavities and convexities on the order of μm.

Despite the fact, references of known arts (Japanese Patent Application Laid-Open No. 11-300768, Japanese Patent Nos. 2533379, 2891344, Japanese Patent Application Laid-Open No. 2000-141481, etc) do not describe countermeasures for such slipping between a sheet and a roller at all, and no solution has been found for the above-described problem.

Moreover, such production line of an emboss sheet used for producing optical sheets involves problems of poor quality due to contamination such as dust and decreased yield.

In particular, if minute contaminants (dust) are attached to the surface of the sheet 3 before transferring the pattern of concavities and convexities of the stamper roller 1 to the sheet 3, the contaminants are incorporated into products, significantly affecting optical properties and quality. Such contaminants must be removed as much as possible at least before a pattern is formed on the surface of the sheet 3 by the stamper roller 1.

Attachment of contaminants includes the following cases:
1) Contaminants already attached to sheet
2) Contaminants already included in radiation curable resin
3) Contaminants generated from a motor used for driving a roller
4) Contaminants generated by scraping of the sheet surface due to slip between a traveling sheet and a roller (often found in sheets whose wrap angle on a roller is small and which travel on a stationary roller)

To deal with the problem of contaminants, the above-described Japanese Patent Application Laid-Open No. 2005-53039, for example, discloses a configuration for removing contaminants on a sheet using an adhesive roller. However, prevention of attachment of minute contaminants (dust) is very difficult only by such an adhesive roller, and deterioration of quality and decrease of yield are unavoidable.

The present invention has been made in view of such circumstances and aims at providing a method and an apparatus for producing an embossed sheet which are suitable for producing a high quality, defect-free embossed sheet having a fine regular pattern of concavities and convexities on the surface at high line speed with high productivity.

### DISCLOSURE OF THE INVENTION

To achieve the aforementioned object, a first aspect of the present invention provides a method of producing an embossed sheet in which a pattern of concavities and convexities on a surface of an emboss roller are transferred and formed on a surface of a sheet-like material, comprising the steps of: allowing a flexible strip-shaped sheet-like material to continuously travel, forming a coating layer by coating the surface of the continuously traveling sheet-like material with a radiation curable resin, transferring the pattern of concavities and convexities on the surface of the emboss roller to the coating layer by winding the continuously traveling sheet-like material around the rotating emboss roller, curing the coating layer by irradiating the layer with radiation with the continuously traveling sheet-like material being wound around the emboss roller, releasing the continuously traveling sheet-like material from the emboss roller, laminating a protective film on one or both sides of the continuously traveling sheet-like material after releasing, and taking up the continuously traveling sheet-like material after lamination in a form of a roll.

To this end, the first aspect of the present invention also provides an apparatus for producing an embossed sheet, comprising: a sheet-like material feeding device for feeding a flexible strip-shaped sheet-like material, a coating device for coating the surface of the sheet-like material with a radiation curable resin to form a coating layer, a drying device for drying a solvent contained in the coating layer, a transferring device for transferring and forming a pattern of concavities and convexities on the surface of an emboss roller to the surface of the sheet-like material with the continuously traveling sheet-like material being wound around the rotating emboss roller, a curing device for curing the coating layer with the sheet-like material being wound around the emboss roller, a releasing device for releasing the sheet-like material from the emboss roller, a laminating device for laminating a protective film on one or both sides of the sheet-like material after releasing, and a sheet-like material take-up device for taking up the sheet-like material after lamination in the form of a roll.

According to the first aspect, in a series of steps from the upstream, a radiation curable resin is applied to the surface of a continuously traveling sheet-like material; the coating layer is cured by irradiation of radiation while winding the sheet-like material around an emboss roller and transferring a pattern of concavities and convexities on the surface of the emboss roller to the sheet-like material; the sheet-like material is released from the emboss roller; a protective film is laminated on one or both sides; and the sheet is taken up in the form of a roll. Accordingly, since procedures up to take up can be performed in a series of steps, high quality, defect-free sheets can be produced at high line speed with high productivity.

The “emboss roller” in the present specification includes not only emboss rollers having a pattern of concavities and convexities (emboss) on a cylindrical roller but also members such as endless belts having a pattern of concavities and convexities (emboss) on the surface of a belt member. This is because such a belt member also has the same function and produces the same effects as do cylindrical emboss rollers.

Preferably, the above method of the first aspect further comprises a step of drying a solvent contained in the coating layer. Since the method has the step of drying a solvent contained in the coating layer before curing the sheet-like material with the sheet-like material being wound around an emboss roller as herein described, there is no fear of deterioration in function of products and decrease in the strength of the cured film due to the solvent added remaining after curing. Neither is there a fear of generation of bad odor due to release of a solvent during use of the product nor resulting adverse effects on health.

Preferably, the above method of the first aspect further comprises a step of controlling a position of the sheet-like material in a width direction by detecting a position of an edge of the continuously traveling sheet-like material in the width direction. Since a fine pattern is formed on the surface of the embossed sheet in the present invention, unevenness or fluctuation in the tension during transfer of sheets easily leads to generation of defects. When the position of the sheet-like material can be controlled in the width direction as herein described, the generation of defects described above can be effectively prevented.

Further, in the first aspect, preferably the sheet-like material is allowed to continuously travel by a driving drum which holds the sheet-like material on the outer surface by sucking and rotates at a pre-determined peripheral speed. When the sheet-like material is allowed to continuously travel by such a driving drum, the traveling speed of the sheet-like material is stable and the pattern of concavities and convexities is transferred in good condition. For such driving drums, drums which hold a sheet-like material by sucking through numerous holes formed on the outer surface and so-called grooved suction drums which hold a sheet-like material by means of a plurality of grooves formed on the outer surface can be used.

Preferably, the above method of the first aspect further comprises a step of controlling a tension of the continuously traveling sheet-like material by a tension control device. When the tension of the sheet-like material is controlled by such a tension control device, the traveling speed of the sheet-like material is stable and the pattern of concavities and convexities is transferred in good condition.

Preferably, the above method of the first aspect further comprises a step of cutting the sheet-like material taken up in a form of a roll into a product size. Preferably, the cutting step is performed off-line after a series of steps.

Preferably, the above method of the first aspect further comprises a step of inspecting a defect in a pattern of concavities and convexities transferred and formed on the sheet-like material. When such an inspection step is included in a series of steps, removal of defect portions is easy.

Preferably, in the above method of the first aspect, the radiation is ultraviolet rays.

To achieve the aforementioned object, a second aspect of the present invention provides a method of producing an embossed sheet in which a pattern of concavities and convexities on a surface of an emboss roller are transferred and formed on a surface of a sheet-like material, comprising the steps of: allowing a flexible strip-shaped sheet-like material on which a resin solution layer is formed by coating the sheet with a resin solution to continuously travel, transferring a pattern of concavities and convexities on the surface of the emboss roller to the resin solution layer by winding the sheet-like material around the rotating emboss roller and pressing the sheet-like material by the emboss roller and a nip roller positioned against the emboss roller, and curing the resin solution layer with the sheet-like material being wound around the emboss roller.

To this end, the second aspect of the present invention also provides an apparatus for producing an embossed sheet, comprising:

a sheet-like material feeding device for feeding a flexible strip-shaped sheet-like material, a coating device for coating the surface of the sheet-like material with a resin solution, a transferring device for transferring and forming a pattern of concavities and convexities on the surface of an emboss roller to the resin solution layer by winding the sheet-like material around the rotating emboss roller and pressing the sheet-like material by the emboss roller and a nip roller positioned against the emboss roller, a resin solution curing device for curing the resin solution with the sheet-like material being wound around the emboss roller, and a releasing device for releasing the sheet-like material after curing the resin solution layer from the emboss roller by winding the sheet-like material around a release roller positioned against the emboss roller.

According to the second aspect, a sheet-like material on which a resin solution layer is formed is wound around a rotating emboss roller and pressed by the emboss roller and a nip roller positioned against the emboss roller to transfer the pattern of concavities and convexities on the surface of the emboss roller to the resin solution layer, and the resin solution layer is cured in that state. At this stage, even if the tension of the traveling sheet-like material fluctuates or is uneven in the vicinity of the emboss roller, slipping does not occur because the sheet-like material is held on the emboss roller by pressing force of the nip roller.

Accordingly, the second aspect can produce a high quality, defect-free embossed sheet having a fine regular pattern of concavities and convexities on the surface at high line speed with high productivity.

Preferably, the above method of the second aspect further comprises a step of releasing the sheet-like material after curing the resin solution layer from the emboss roller by winding the sheet-like material around a release roller positioned against the emboss roller. When the sheet-like material after curing is released from the emboss roller by winding the sheet-like material around the release roller as herein described, the sheet-like material can be released well and the pattern of concavities and convexities is transferred at high accuracy.

Further, in the second aspect, preferably the emboss roller is provided between the nip roller and the release roller and the emboss roller is pressed by the nip roller and the release roller. In such a configuration in which the emboss roller is pressed by the nip roller and the release roller, the sheet-like material can be pressed by the nip roller well and the pattern of concavities and convexities is transferred at high accuracy.

Further, in the second aspect, preferably the resin solution is a radiation curable resin solution and the resin solution layer is cured by irradiating the resin solution layer with radiation. Use of such a radiation curable resin solution makes curing of resin easier.

Further, in the second aspect, preferably pressing is performed at 0.01 to 1.0 kgf/mm. When the pressing force is in this range, the pattern of concavities and convexities is transferred at high accuracy. The pressing force means a pushing force (kgf) by a nip roller divided by the width of the roller (mm). More preferably, pressing is performed at 0.05 to 0.5 kgf/mm.

Further, in the second aspect, preferably the surface of the nip roller and/or the release roller is formed from a material having a rubber hardness in accordance with JIS (Japanese Industrial Standards) K6253 of 40 to 80 degrees. Such a nip roller and/or a release roller perform pressing appropriately and cause no slipping of the sheet-like material on the emboss roller.

Further, the above method of the second aspect preferably comprises a step of drying a solution in the resin solution layer.

Further, the above method of the second aspect preferably comprises a step of controlling a position of the sheet-like material in a width direction by detecting a position of an edge of the continuously traveling sheet-like material in the width direction.

Further, in the second aspect, preferably the sheet-like material is allowed to continuously travel by a driving drum which holds the sheet-like material on the outer surface by sucking and rotates at a pre-determined peripheral speed. When the sheet-like material is allowed to continuously travel by such a driving drum, the traveling speed of the sheet-like material is stable and the pattern of concavities and convexities is transferred in good condition. For such driving drums, drums which hold a sheet-like material by sucking through numerous holes formed on the outer surface and so-called grooved suction drums which hold a sheet-like material by means of a plurality of grooves formed on the outer surface can be used.

Preferably, the above method of the second aspect further comprises a step of controlling a tension of the continuously traveling sheet-like material by a tension control device. When the tension of the sheet-like material is controlled by such a tension control device, the traveling speed of the sheet-like material is stable and the pattern of concavities and convexities is transferred in good condition.

Further, the above method of the second aspect preferably comprises a step of inspecting a defect in the pattern of concavities and convexities transferred and formed on the sheet-like material.

Further, in the above method of the second aspect, preferably the radiation is ultraviolet lays.

To achieve the aforementioned object, a third aspect of the present invention provides a method of producing an embossed sheet in which a pattern of concavities and convexities on the surface of an emboss roller are transferred and formed on the surface of a sheet-like material, comprising the steps of: allowing a flexible strip-shaped sheet-like material to continuously travel, removing foreign substances from the surface of the continuously traveling sheet-like material, forming a coating layer by coating with a radiation curable resin the surface of the continuously traveling sheet-like material from which foreign substances are removed, transferring the pattern of concavities and convexities on the surface of the emboss roller to the coating layer by winding the continuously traveling sheet-like material around the rotating emboss roller, curing the coating layer by irradiating the layer with radiation with the continuously traveling sheet-like material being wound around the emboss roller, and releasing the continuously traveling sheet-like material from the emboss roller.

According to the third aspect, in a series of steps from the upstream, a radiation curable resin is applied to the surface of a continuously traveling sheet-like material; the coating layer is cured by irradiation of radiation while winding the sheet-like material around an emboss roller and transferring a pattern of concavities and convexities on the surface of the emboss roller to the sheet-like material; the sheet-like material is released from the emboss roller; a protective film is laminated on one or both sides; and the sheet is taken up in the form of a roll. Accordingly, since procedures up to take up can be performed in a series of steps, high quality, defect-free sheets can be produced with high productivity.

In particular, since a radiation curable resin is applied after the step of removing foreign substances from the surface of the sheet-like material, preventing minute contaminants (dust) from attaching is easy and therefore a high quality, defect-free embossed sheet having a fine regular pattern of concavities and convexities on the surface can be produced with high productivity.

In the third aspect, preferably a dry or wet type cleaning device is used in the step of removing foreign substances from the surface of the sheet-like material. When a dry or wet type cleaning device is used for removing foreign substances as herein descried, minute contaminants (dust) can be easily removed.

A dry type cleaning device means a so-called dry cleaning device. Examples thereof include devices using inert gas, vapor, plasma, ultraviolet rays or other devices (devices using an adhesive roller). Examples of wet type cleaning devices include devices using a solvent, a detergent or ultrapure water.

Preferably, the above method of the third aspect further comprises a step of filtering the radiation curable resin with a filtering device having a pore diameter of less than 10 μm before coating. Such filtering efficiently removes contaminants originally contained in the radiation curable resin. Filtering may be performed upon supplying (coating) of the resin solution (an on-line system) or previously in a separate tank (an off-line system).

Further, in the third aspect, preferably the sheet-like material is held by a roller member, a driving device is provided on the roller member on which the sheet-like material is held at a wrap angle of less than 20 degrees and the peripheral speed of the roller member is brought in line with the traveling speed of the sheet-like material in the step of allowing the sheet-like material to continuously travel.

When a driving means is provided on a roller member on which the sheet-like material is held at a small wrap angle and the peripheral speed of the roller member is brought in line with the traveling speed of the sheet-like material, no contaminant is generated by scraping of the sheet surface due to slip between the traveling sheet-like material and the roller.

Further, in the third aspect, preferably cleanliness in the step of forming a coating layer is kept at less than class 1000 and cleanliness in the respective steps is kept at less than class 5000. By keeping not only the coating step but also all the steps at an appropriate cleanliness, a high quality, defect-free embossed sheet can be produced with high productivity.

Further, in the third aspect, preferably in the respective steps, a dust-generating site is covered with a case and sealed and the pressure inside the case is reduced by a suction means communicated therewith. By covering the dust-generating site with a case and reducing the pressure inside the case, dust is not generated in the steps and no contaminant is generated from a motor used for driving a roller.

Further, in the third aspect, preferably the transferring is performed while pressing the sheet-like material by the emboss roller and a nip roller positioned against the emboss roller.

Further, the method of the third aspect preferably comprises a step of releasing the sheet-like material after curing the resin from the emboss roller by winding the sheet-like material around a release roller positioned against the emboss roller.

Further, the method of the third aspect preferably comprises a step of controlling a position of the sheet-like material in a width direction by detecting a position of an edge of the continuously traveling sheet-like material in the width direction.

Further, in the method of the third aspect, preferably the sheet-like material is allowed to continuously travel by a driving drum which holds the sheet-like material on an outer surface by sucking and rotates at a predetermined peripheral speed.

Further, the method of the third aspect preferably comprises a step of cutting the sheet-like material taken up in a form of a roll into a product size.

Further, the method of the third aspect preferably comprises a step of controlling a tension of the continuously traveling the sheet-like material by a tension control means.

Further, the method of the third aspect preferably comprises a step on inspecting a defect in the pattern of concavities and convexities transferred and formed on the sheet-like material.

Further, in above-described aspects, preferably a pattern of concavities and convexities transferred and formed on the sheet-like material has a pitch of 100 μm or less. Further, in above-described aspects, preferably the embossed sheet is used as an optical film.

As described above, according to the present invention, a high quality, defect-free embossed sheet having a fine regular pattern of concavities and convexities on the surface can be produced with high productivity or at high line speed with high productivity.

### BRIEF DESCRIPTION OF THE DRAWINGS

FIG. 1 is a view showing a configuration of an apparatus for manufacturing an embossed sheet, to which the present invention is applied;

FIG. 2 is a sectional view showing an outline of an emboss roller;

FIG. 3 is a sectional view showing an outline of an embossed sheet;

FIG. 4 is a conception diagram showing a configuration of an apparatus for manufacturing an embossed sheet according to a conventional embodiment;

FIG. 5 is a conception diagram showing another configuration of an apparatus for manufacturing an embossed sheet according to a conventional embodiment;

FIG. 6 is a table showing the formulation of a resin solution according to a third embodiment;

FIG. 7 is a table showing a condition and a result of Example in a third embodiment; and

FIG. 8 is a table showing the number of defects in Example and Comparative Example in a third embodiment.

### DESCRIPTION OF REFERENCE NUMERAL

10 . . . apparatus for manufacturing embossed sheet

11 . . . sheet-feeding means

12 . . . coating means

13 . . . emboss roller

14 . . . nip roller

15 . . . resin curing means

16 . . . release roller

17 . . . protective-film-feeding means

18 . . . sheet-winding means

21 . . . defect inspection means

24 . . . first suction drum

26 . . . second suction drum

28 . . . dust collector

30 . . . dancer roller

32 . . . edge position control means

H . . . protective film

W . . . sheet

### BEST MODE FOR CARRYING OUT THE INVENTION

### First Embodiment

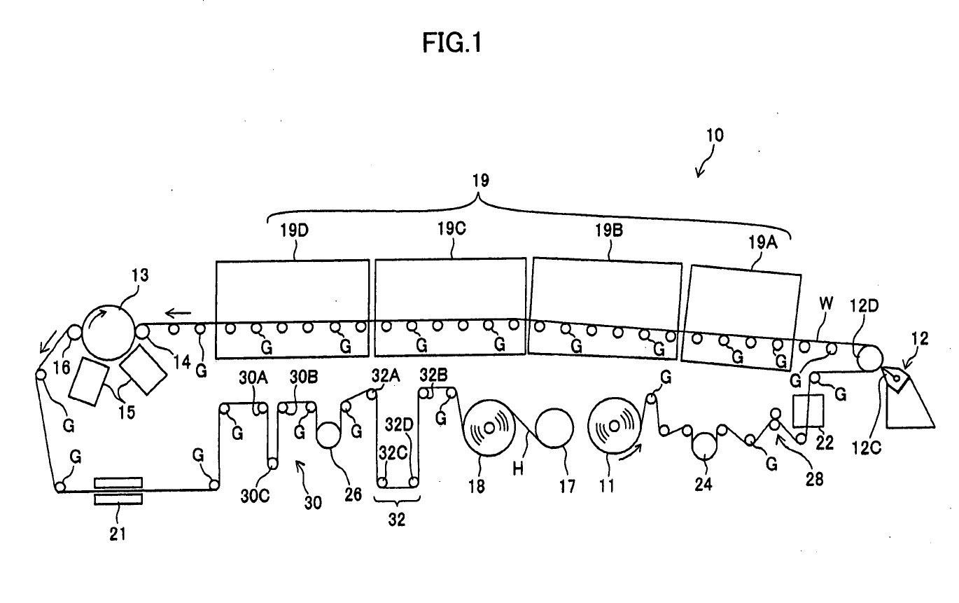

In the next place, a first embodiment according to the present invention will be described on the basis of attached drawings. FIG. 1 is a view showing a configuration of an apparatus 10 for manufacturing an embossed sheet, to which the present invention is applied.

The apparatus 10 for manufacturing the embossed sheet is composed of sheet-like material feeding means 11, coating means 12, drying means 19, an emboss roller 13 having a concavo-convex surface, a nip roller 14, resin-curing means 15, a release roller 16, defect inspection means 21, protective-film feeding means 17 and sheet-winding means 18. A sheet W of a sheet-like material is supported and transported by guide rollers G to G from an upstream side (sheet feeding means 11) to a downstream side (sheet-winding means 18).

The sheet-feeding means 11 as a sheet-like material feeding means feeds a sheet W of a sheet-like material and is composed of a pay-off roll around which the sheet W is wound and so on.

Between the sheet-feeding means 11 and the coating means 12, a first suction drum 24 is arranged. The first suction drum 24 is means for continuously traveling the sheet W by holding the sheet W by absorbing it and at the same time by rotationally driving at predetermined peripheral velocity, same as the second suction drum 26 described later. The drum for holding the sheet W have a configuration of the absorbing it through many holes opened in the outer surface of a drum and have a configuration (grooved suction drum) of holding it by a plurality of grooves formed in the outer surface of the drum.

A dust collector 28 is installed in the downstream of the first suction drum 24. The dust collector 28 removes deposited dust on the surface of the sheet W. The dust collector 28 can adopt various well-known types such as a type of spraying dried air from which the dust has been electrostatically removed and a type of making an adhesive roller wind the sheet W as shown in a drawing.

Coating means 12 is a device for applying a liquid containing a radiation curable resin onto the surface of the sheet W, and is composed of a liquid-supplying source for supplying the liquid containing the radiation curable resin; a liquid-supplying device (liquid-supplying pump) (though the above components are not drawn in FIG. 1); a coating head 12C; a support roller 12D for supporting the sheet W to be coated by winding it, and a pipe which is not illustrated but supplies the liquid containing the radiation curable resin from the liquid-supplying source to the coating head 12C. An adopted coating head 12C here is a coating head of a die coater (extrusion coater).

Any well-known drying means 19 can be adopted, as long as it can uniformly dry a coating solution on the sheet W such as a tunnel-shaped drying apparatus shown in FIG. 1. The adoptable drying means includes, for instance, a radiation heating type with the use of a heater, a hot blast circulation type, a far infrared ray type and a vacuum type.

The drying means 19 shown in FIG. 1 is divided into four blocks of the tunnel-shaped apparatuses, which are the first block 19A, the second block 19B, the third block 19C and the fourth block 19D arranged in this order from the upstream. Then temperature in each block can be separately set.

An emboss roller 13 is required to have such a precise pattern of concavities and convexities, mechanical strength and circularity as to be able to transfer and form the pattern of concavities and convexities of the roller surface onto the surface of the sheet W. A metallic roller is preferable for such an emboss roller 13.

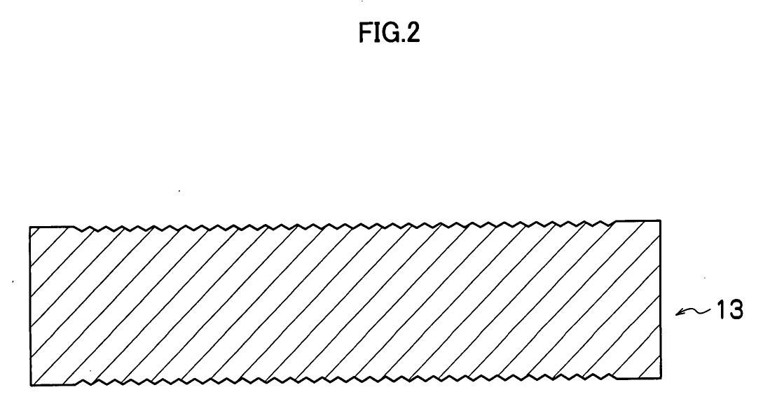

The emboss roller 13 has a regular pattern of fine concavities and convexities formed on the outer surface. The regular pattern of fine concavities and convexities is required to have a reversed shape of the pattern of fine concavities and convexities to be formed on the surface of an embossed sheet of a product. A schematic cross-sectional view of the emboss roller 13 is shown in FIG. 2.

The product of the embossed sheet is used, for instance, for a lenticular lens on which the patterns of fine concavities and convexities are two-dimensionally arranged, a fly-eye lens in which the patterns of fine concavities and convexities are three-dimensionally arranged, and a flat lens in which fine cones of a circular cone, pyramid or the like spread in an XY direction, so that a regular pattern of fine concavities and convexities formed on the outer surface of the emboss roller 13 shall correspond to the above pattern.

An adoptable method for forming the regular pattern of fine concavities and convexities on the outer surface of the emboss roller 13 includes the method of cutting the surface of the emboss roller 13 with a diamond turning tool (single point); the method of directly forming a pattern of concavities and convexities on the surface of the emboss roller 13 by photo etching, electron beam lithography and laser machining; and the method of forming the pattern of concavities and convexities on the surface of a metallic thin sheet by photo etching, electron beam lithography, laser machining or laser beam lithography and then winding the sheet around the roller and fixing it to form the emboss roller 13.

The adoptable method further includes a method of forming a pattern of concavities and convexities on the surface of a material which is more easily worked than a metal, by photo etching, electron beam lithography, laser machining and laser beam lithography, then forming a metallic thin sheet having the reverse mold of the shape by electroforming, and winding the metallic sheet around the roller and fixing it to form the emboss roller 13. Among them, the method of forming the reverse mold by electroforming has an advantage of obtaining a plurality of the metallic sheets having the same shape from one master (mother).

The surface of the emboss roller 13 is preferably submitted to mold release treatment. Thus mold-release-treated surface of the emboss roller 13 can maintain the shape of the pattern of fine concavities and convexities well. An adoptable mold-release treatment method includes various well-known methods such as fluororesin coating treatment. The emboss roller 13 is preferably provided with drive means. The emboss roller 13 rotates in a clockwise direction (CW) as indicated by an arrow in FIG. 1.

A nip roller 14 is a device which pairs with an emboss roller 13 to roll-form the sheet W while pressing it, and accordingly is required to have predetermined mechanical strength and circularity. The surface part of the nip roller 14 has preferably an appropriate modulus of longitudinal elasticity (Young's modulus), because when the modulus is too low, the nip roller insufficiently roll-forms the sheet, and when it is too high, the nip roller sensitively responds to foreign substances such as contaminants and tends to cause a defect. The nip roller 14 is preferably provided with drive means. The nip roller 14 rotates in a counter clockwise direction (CCW) as indicated by an arrow in FIG. 1.

It is preferable to install pressure-applying means to either of the emboss roller 13 and the nip roller 14 in order to apply predetermined pressing force between the emboss roller 13 and the nip roller 14. Similarly, it is preferable to install such fine adjustment means as to be able to precisely control a gap (clearance) between the emboss roller 13 and the nip roller 14, in either of the emboss roller 13 and the nip roller 14.

Resin-curing means 15 is light irradiation means installed so as to face an emboss roller 13 in a downstream side of a nip roller 14. The resin-curing means 15 cures a resin solution layer by irradiating it with light after having made the light pass through a sheet W, accordingly can preferably emit light (radiation) having such a wavelength as to match the curing characteristics of a resin and can emit radiation having such intensity as to match a traveling speed of the sheet W. Adoptable resin-curing means 15 is, for instance, a cylindrical illumination lamp with a length approximately equal to a width of the sheet W. A plurality of the cylindrical illumination lamps can be also arranged in parallel, and a reflecting plate can be also arranged on the back of the cylindrical illumination lamp. In the present embodiment as shown in FIG. 1, two sets of lamp houses are arranged each of which has the cylindrical illumination lamp accommodated in a housing.

A release roller 16 is a device for releasing the sheet W from an emboss roller 13 while pairing with the emboss roller 13, and accordingly is required to have predetermined mechanical strength and circularity. At a releasing point, the release roller 16 releases the sheet W from the emboss roller 13 while pinching the sheet W wound around the periphery of the emboss roller 13 between the rotating emboss roller 13 and the release roller 16, and winds the sheet W around the release roller 16. In order to ensure the operation, the release roller 16 is preferably provided with drive means. The release roller 16 rotates in a counter clockwise direction (CCW) as indicated by an arrow in FIG. 1.

When a resin or the like raises its temperature by being cured, a release roller 16 can be also provided with cooling means for cooling a sheet W so that the sheet W can be reliably released.

In another adoptable configuration though it is not shown in FIG. 1, a plurality of back-up rollers are installed so as to face an emboss roller 13 between a pressing point (position of 0°) of an emboss roller 13 and a releasing point (position of 180°) on the emboss roller 13 and press a sheet W together with the emboss roller 13, and the coated resin is cured during it.

Defect inspection means 21 is arranged in a downstream side of a release roller 16. The defect inspection means 21 can inspect defects of the transferred and formed the pattern of concavities and convexities on a sheet W, and easily removes the defects. A usable type of the defect inspection means 21 includes various well-known types of inspection devices (such as charge-coupled imaging device).

A dancer roller 30 of tension control means is arranged in a downstream side of defect inspection means 21. The dancer roller 30 is composed of fixed rollers 30A and 30B and a traveling roller 30C arranged between the fixed rollers 30A and 30B. The dancer roller 30 controls a tensile force of a sheet W by hoisting and lowering the traveling roller 30C.

A second suction drum 26 is arranged in a downstream side of a dancer roller 30. The second suction drum 26 is means for continuously traveling the sheet W by holding the sheet W by absorbing it and at the same time by rotationally driving the dram at predetermined peripheral velocity, same as the first suction drum 24 as was already described.

Edge position control means (edge position controller) 32 is arranged in a downstream side of a second suction drum 26. The edge position control means 32 is a device for detecting an edge position in a width direction of a continuously-traveling sheet W and controlling a position in the width direction of the sheet W.

The edge position control means 32 is composed of fixed rollers 32A and 32B and tilting rollers 32C and 32D arranged between the fixed rollers 32A and 32B. The edge position control means controls a position in a width direction of a sheet W, by making an edge position sensor (such as a laser type position sensor) which is not shown in FIG. 1 detect the position of the sheet W, and making the gradient rollers 32C and 32D tilt on the basis of the detected result so that the position in the width direction of the sheet W becomes proper.

Sheet-winding means 18 accommodates a released sheet W and is composed of a winding roll for winding up the sheet W. In the sheet-winding means 18, a protective film H is fed onto the surface of the sheet W from adjacently installed protective-film-feeding means 17, and the sheet-winding means 18 accommodates both films in their overlapping state.

In the next place, each material applied to the present invention will be described. A usable sheet W includes a resin film, paper (resin coated paper, synthetic paper), a metallic foil (aluminum web) and the like. A usable material of a resin film includes well-known materials such as polyethylene, polypropylene, polyvinyl chloride, polyvinylidene chloride, polyvinyl acetate, polyester, polyolefin, acrylic, polystylene, polycarbonate, polyamide, PET (polyethylene terephthalate), biaxially-stretched polyethylene terephthalate, polyethylenenaphthalate, polyamide-imide, polyimide, aromatic polyamide, cellulose acylate, cellulose triacetate, cellulose acetate propionate and cellulose diacetate. Among them, polyester, cellulose acylate, acrylic, polycarbonate and polyolefin can be preferably used in particular.

A sheet W to be generally adopted has a width of 0.1 to 3 m, a length of 1,000 to 100,000 m, and a thickness of 1 to 300 μm. However, a sheet W having another size than them may be used.

The sheet W may be previously submitted to corona discharge treatment, plasma treatment, adhesion-facilitating treatment, heat treatment, dust removal treatment or the like. The sheet W preferably has a surface roughness Ra of 3 to 10 nm when a cutoff value is set at 0.25 mm.

In addition, a sheet W to be used may be previously provided with an underlayer such as a dried and cured adhesive layer, or may previously have another functional layer formed on its back face. Similarly, a sheet W composed of not only one layer but also two or more layers can be adopted. In addition, the sheet W is preferably transparent or translucent to pass light through the sheet W.

A resin usable in the present invention contains a compound containing a reactive group such as a (meth)acryloyl group, a vinyl group and an epoxy group, and such a compound as to produce radical or cation active species capable of making the compound containing the reactive group, when irradiated with radiation such as ultraviolet rays.

Particularly, from the viewpoint of a speed to be cured, the resin preferably contains a compound (monomer) containing a reactive group containing an unsaturated group such as a (meth)acryloyl group and a vinyl group in combination with a light radical-polymerization initiator which produces a radical group due to light. Among them, a preferred compound contains a (meth)acryloyl group such as (meth)acrylate, urethane (meth)acrylate, epoxy (meth)acrylate and polyester (meth)acrylate.

A usable compound containing the (meth)acryloyl group includes a compound containing one or more (meth)acryloyl groups. In addition, it is acceptable to singly use the compound (monomer) containing the reactive group containing the above described unsaturated group such as the acryloyl group and the vinyl group, or a plurality of the compounds by mixing them, as needed.

Among compounds containing such a (meth)acryloyl group, a single function-group monomer containing only one (meth)acryloyl group includes, for instance, isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, and methoxypolypropylene glycol (meth)acrylate.

Furthermore, a single function-group monomer having an aromatic ring includes phenoxyethyl (meth)acrylate, phenoxy-2-methylethyl (meth)acrylate, phenoxyethoxyethyl (meth)acry late, 3-phenoxy-2-hydroxypropyl (meth)acrylate, 2-phenylphenoxyethyl (meth)acrylate, 4-phenylphenoxyethyl (meth)acrylate, 3-(2-phenyl phenyl)-2-hydroxypropyl (meth)acrylate, (meth)acrylate of P-cumylphenol reacted with ethylene oxide, 2-bromophenoxyethyl (meth)acrylate, 4-bromophenoxyethyl (meth)acrylate, 2,4-dibromophenoxyethyl (meth)acrylate, 2,6-dibromophenoxyethyl (meth)acrylate, 2,4,6-tribromophenyl (meth)acrylate, and 2,4,6-tribromophenoxyethyl (meth)acrylate.

A commercially available product of such a single function-group monomer having an aromatic ring includes Aronics M113, M110, M101, M102, M5700 and TO-1317 (all manufactured by Toagosei Co., Ltd.); Biscoat #192, #193, #220 and 3BM (all manufactured by Osaka Organic Chemical Industry Ltd.); NK Ester AMP-10G and AMP-20G (all manufactured by Shin-Nakamura Chemical Co., Ltd.); Light Acrylate PO-A and P-200A, Epoxy Ester M-600A and Light Ester PO (all manufactured by Kyoeisha Chemical Co., Ltd.); and New Frontier PHE, CEA, PHE-2, BR-30, BR-31, BR-31M and BR-32 (all manufactured by Dai-ichi Kogyo Seiyaku Co., Ltd.).

In addition, an unsaturated monomer having two (meth)acryloyl groups in a molecule includes an alkyldiol diacrylate such as 1,4-butanediol diacrylate, 1,6-hexanediol diacrylate and 1,9-nonanediol diacrylate; a polyalkylene glycol diacrylate such as ethylene glycol di(meth)acrylate, tetraethylene glycol diacrylate and tripropylene glycol diacrylate, neopentyl glycol di(meth)acrylate and tricyclodecanemethanol diacrylate.

An unsaturated monomer having a bisphenol skeleton includes ethylene oxide added bisphenol A (meth)acrylate, ethylene oxide added tetrabromobisphenol A (meth)acrylate, propylene oxide added bisphenol A (meth)acrylate, propylene oxide added tetrabromobisphenol A (meth)acrylate, bisphenol A epoxy (meth)acrylate produced by epoxy ring-opening reaction of bisphenol A diglycidyl ether with (meth)acrylic acid, tetrabromobisphenol A epoxy (meth)acrylate produced by epoxy ring-opening reaction of tetrabromobisphenol A diglycidyl ether with (meth)acrylic acid, bisphenol F epoxy (meth)acrylate produced by epoxy ring-opening reaction of bisphenol F diglycidyl ether with (meth)acrylic acid, and tetrabromobisphenol F epoxy (meth)acrylate produced by epoxy ring-opening reaction of tetrabromo bisphenol F diglycidyl ether with (meth)acrylic acid.

A commercially available product of an unsaturated monomer having such a structure includes Biscoat #700 and #540 (all manufactured by Osaka Organic Chemical Industry Ltd.); Aronics M-208 and M-210 (all manufactured by Toagosei Co., Ltd.); NK Ester BPE-100, BPE-200, BPE-500 and A-BPE-4 (all manufactured by Shin-nakamura Chemical Co., Ltd.); Light Ester BP-4EA and BP-4PA, and Epoxy Ester 3002M, 3002A, 3000M and 3000A (all manufactured by Kyoeisha Chemical Co., Ltd.); KAYARADR-551 and R-712 (all manufactured by Nippon Kayaku Co., Ltd.); BPE-4, BPE-10 and BR-42M (all manufactured by Dai-ichi Kogyo Seiyaku Co., Ltd); Lipoxy VR-77, VR-60, VR-90, SP-1506, SP-1506, SP-1507, SP-1509 and SP-1563 (all manufactured by Showa Highpolymer Co., Ltd.); and Neopol V779 and Neopol V779MA (manufactured by Japan U-PiCA Company, Ltd.).

Furthermore, an unsaturated (meth)acrylate monomer having three or more function groups includes a (meth)acrylate of polyhydric alcohol having three or more valencies such as trimethylolpropane tri(meth)acrylate, pentaerythritol tri(meth)acrylate, trimethylolpropanetrioxyethyl (meth)acrylate and tris(2-acryloyloxyethyl) isocyanurate. A commercially available product includes Aronics M305, M309, M310, M315, M320, M350, M360 and M408 (manufactured by Toagosei Co., Ltd.); Biscoat #295, #300, #360, GPT, 3PA and #400 (all manufactured by Osaka Organic Chemical Industry Ltd.); NK Ester TMPT, A-TMPT, A-TMM-3, A -TMM-3 L and A-TMMT (all manufactured by Shin-nakamura Chemical Co., Ltd.); Light Acrylate TMP-A, TM P-6EO-3A, PE-3A, PE-4A and DPE-6A (all manufactured by Kyoeisha Chemical Co., Ltd.); and KAYARADPET-30, GPO-303, TMPTA, TPA-320, DPHA, D-310, DPCA-20 and DPCA-60 (all manufactured by Nippon Kayaku Co., Ltd.).

In addition, a compound containing the (meth)acryloyl group may be blended with an oligomer of a urethane (meth)acrylate. The urethane (meth)acrylate includes: a polyether polyol such as polyethylene glycol and polytetramethyl glycol; a polyester polyol produced by a reaction of a dibasic acid such as succinic acid, adipic acid, azelaic acid, sebacic acid, phthalic acid, tetrahydro (anhydrous) phthalic acid and hexahydro (anhydrous) phthalic acid, with a diol such as ethylene glycol, propylene glycol, diethylene glycol, triethylene glycol, tetraethylene glycol, dipropylene glycol, 1,4-butanediol, 1,6-hexanediol and neopentyl glycol; alkyl polyol such as poly-ε-caprolactone denatured polyol; polymethyl valerolactone denatured polyol; ethylene glycol, propylene glycol, 1,4-butanediol, 1,6-hexanediol and neopentyl glycol; bisphenol A skeleton alkylene oxide denatured polyol such as ethylene oxide added bisphenol A and propylene oxide added bisphenol A; bisphenol F skeleton alkylene oxide denatured polyol such as ethylene oxide added bisphenol F and propylene oxide added bisphenol F, or a mixture thereof; an organic polyisocyanate such as tolylene diisocyanate, isophorone diisocyanate, hexamethylene diisocyanate, diphenylmethane diisocyanate and xylylene diisocyanate; and a (meth)acrylate containing a hydroxy group such as 2-hydroxyethyl (meth)acrylate and 2-hydroxypropyl (meth)acrylate. An oligomer of urethane (meth)acrylate is preferable for keeping the viscosity of a curable composition according to the present invention appropriate.

A commercially available monomer of these urethane (meth)acrylates includes, for instance, Aronics M120, M-150, M-156, M-215, M-220, M-225, M-240, M-245 and M-270 (all manufactured by Toagosei Co., Ltd.); AIB, TBA, LA, LTA, STA, Biscoat #155, IBXA, Biscoat #158, #190, #150, #320, HEA, HPA, Biscoat #2000, #2100, DMA, Biscoat #195, #230, #260, #215, #335HP, #310HP, #310HG and #312 (all manufactured by Osaka Organic Chemical Industry Ltd.); Light Acrylate IAA, L-A, S-A, BO-A, EC-A, MTG-A, DMP-A, THF-A, IB-XA, HOA, HOP-A, HOA-MPL and HOA-MPE, Light Acrylate 3EG-A, 4EG-A, 9EG-A, NP-A, 1,6HX-A and DCP-A (all manufactured by Kyoeisha Chemical Co., Ltd.); KAYARADTC-110S, HDDA, NPGDA, TPGDA, PEG 400DA, MANDA, HX-220 and HX-620 (all manufactured by Nippon Kayaku Co., Ltd.); FA-511 A, 512A and 513A (all manufactured by Hitachi Chemical Co., Ltd.); VP (manufactured by BASF A.G.); and ACMO, DMAA and DMAPAA (all manufactured by KOHJIN Co., Ltd).

An oligomer of urethane (meth)acrylate is a reactant of (a) a (meth)acrylate containing a hydroxy group, (b) an organic polyisocyanate and (c) a polyol, but is preferably produced by reacting (a) the (meth)acrylate containing the hydroxy group with (b) the organic polyisocyanate and subsequently reacting the reactant with (c) the polyol.

The above described unsaturated monomer may be singly used, or may be used in a mixed form of a plurality of monomers, as needed.

A light radical-polymerization initiator includes, for instance, acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholinopropan-1-one, 2,4,6-trimethylbenzoyidiphenylphosphine oxide, bis-(2,6-dimethoxybenzoyl)-2,4,4-trimethyl pentylphosphine oxide, and ethyl-2,4,6-trimethylbenzoylethoxyphenylphosph ine oxide.

A commercially available product of a light radical-polymerization initiator includes, for instance, Irgacure 184, 369, 651, 500, 819, 907, 784, 2,959, CGI1700, CGI1750, CGI11850 and CG24-61 and Darocur 1116 and 1173 (all manufactured by Ciba Specialty Chemicals); Lucirin LR8728 and 8893X (all manufactured by BASF A.G.); Ubecryl P36 (manufactured by UCB Company); and KIP150 (manufactured by Lanbelty Corporation). Among them, Lucirin LR8893X is preferable because of being a liquid, being easily dissolvable in a solvent and having high sensitivity.

A light radical-polymerization initiator in an amount preferably of 0.01 to 10 wt % and particularly preferably of 0.5 to 7 wt % is blended with respect to all the compositions. An upper limit of an amount to be blended is preferably in the range from the viewpoint of curing characteristics of the composition, mechanical properties and optical characteristics of a cured substance, and the handling easiness of the composition. On the other hand, the lower limit of the amount to be blended is preferably in the range in order to prevent a curing speed from lowering.

A composition according to the present invention can further contain a photosensitizing agent. The photosensitizing agent includes, for instance, triethylamine, diethylamine, N-methyldiethanolamine, ethanolamine, 4-dimethylaminobenzoic acid, 4-dimethyl aminomethyl benzoate, 4-dimethyl ethyl aminobenzoate and 4-dimethylaminobenzoic acid isoamyl. A commercially available product includes, for instance, Ubecryl P102, 103, 104 and 105 (all manufactured by UCB Company).

The composition can still further includes various additives in addition to the above described components, as needed. The various additives includes, for instance, an oxidation inhibitor, an ultraviolet absorber, a light stabilizer, a silane coupling agent, a coated-surface modifier, a heat polymerization inhibitor, a leveling agent, a detergent, a coloring agent, a preservation stabilizer, a plasticizer, a lubricant, a solvent, a filler, an antioxidant, a wettability modifier and a mold lubricant.

In the above description, the oxidation inhibitor includes, for instance, Irganox 1010, 1035, 1076 and 1222 (all manufactured by Ciba Specialty Chemicals); and Antigen P, 3C, FR and GA-80 (manufactured by Sumitomo Chemical Co., Ltd.). The ultraviolet absorber includes, for instance, Tinuvin P, 234, 320, 326, 327, 328, 329 and 213 (all manufactured by Ciba Specialty Chemicals); and Seesorb 102, 103, 110, 501, 202, 712 and 704 (all manufactured by Shipro Kasei Kaisha, Ltd.). The light stabilizer includes, for instance, Tinuvin 292, 144 and 622LD (all manufactured by Ciba Specialty Chemicals); SanolLS770 (manufactured by Sankyo Co., Ltd.); and Sumisorb TM-061 (manufactured by Sumitomo Chemical Co., Ltd.). The silane coupling agent includes, for instance, γ-aminopropyltriethoxysilane, γ-mercaptopropyltrimethoxysilane and γ-methacryloxypropyltrimethoxysilane. A commercially available product includes SH6062 and 6030 (all manufactured by Dow Corning Toray Co., Ltd.); and KBE 903, 603 and 403(manufactured by Shin-Etsu Chemical Co., Ltd.). A coated surface modifier includes, for instance, a silicone additive such as dimethylsiloxane polyeter and a nonionic fluorosurfactant. A commercially-available product of the silicone additive includes DC-57 and DC-190 (all manufactured by Dow Corning Corporation); SH-28PA, SH-29PA, SH-30PA and SH-190 (all manufactured by Dow Corning Toray Co., Ltd.); KF351, KF352, KF353 and KF354 (all manufactured by Shin-Etsu Chemical Co., Ltd.); and L-700, L-7002, L-7500 and FK-024-90 (all manufactured by Nippon Unicar Co., Ltd.). A commercially available product of the nonionic fluorosurfactant includes FC-430 and FC-171 (all manufactured by 3M Co., Ltd.); and Megafac F-176, F-177, R-08 and F780(all manufactured by Dainippon Ink & Chemicals, Inc.). The mold lubricant includes Prisurf A208F (manufactured by Dai-ichi Kogyo Seiyaku Co., Ltd.).

The organic solvent for controlling the viscosity of a resin solution according to the present invention may be any solvent that can be mixed with the resin solution without causing ununiformity such as precipitation, phase separation and cloudiness; and includes, for instance, acetone, methyl ethyl ketone, methyl isobutyl ketone, ethanol, propanol, butanol, 2-methoxy ethanol, cyclohexanol, cyclohexane, cyclohexanone and toluene. A mixed liquid of plurality of the above solvents may be used, as needed.

When an organic solvent is added to the resin solution, the organic solvent requires a step of being dried or being evaporated in a production process. When a large amount of the solvent remains in a product even after having been evaporated, the remaining solvent may deteriorate mechanical properties of the product, vaporize and spread while the product is used, emits a bad smell, and adversely affects the health of people in the environment. Accordingly, an organic solvent with a high boiling point is not preferable because of increasing the amount of the remaining solvent.

However, when the solvent has too low boiling point, the solvent may deteriorate the surface state because of rapidly vaporizing, form dew on the surface of a composition due to vaporization heat in a drying step to form a surface defect due to the trace of the dew, and increase vapor density in a production environment to increase the danger of inflammation and the like.

Accordingly, the organic solvent has a boiling point preferably of 50° C. or higher but 150° C. or lower, and more preferably of 70° C. or higher but 120° C. or lower. From the viewpoint of the solubility of a base material and a boiling point, preferred organic solvents are methyl ethyl ketone (with boiling point of 79.6° C.) and 1-propanol (with boiling point of 97.2° C.).

An amount of an organic solvent to be added to a resin solution according to the present invention is in a range of 10 wt % or more but 40 wt % or less, and preferably is in a range of 15 wt % or more but 30 wt % or less in order to sufficiently improve the application properties of the mixture, though depending on a type of the solvent and viscosity of the resin solution before being mixed with the solvent. When the amount of the added organic solvent is too small, the organic solvent does not show little effect of lowering the viscosity and increasing the amount of the mixture to be applied, and consequently does not sufficiently improve the application properties.

However, when a resin solution is too much diluted by a solvent, the mixed liquid tends to flow on the sheet-like material due to too its low viscosity, and consequently causes a problem of causing unevenness on the body and flowing to the back surface of the material. In addition, a large amount of the organic solvent remains in a product because of being not perfectly dried in a drying step, and may deteriorate a function of the product, produce a bad smell by volatilizing while the product is used, and adversely affect health.

A resin solution according to the present invention can be prepared by mixing the above described respective components with a conventional method, through dissolving them by heating as needed. Thus prepared resin solution has the viscosity of normally 10 to 50,000 mPa·s/25° C.

When a resin solution is supplied on a sheet W and an emboss roller 13, a resin solution should not have too high viscosity, because the composition is hardly supplied uniformly, causing coating unevenness, coating waviness and contamination of bubbles while manufacturing a lens, hardly provides the objective thickness of the lens, and can not give the lens sufficient performance.

Particularly when a line speed becomes higher, the above tendency becomes remarkable. Accordingly, in this case, the liquid has preferably low viscosity in a range of preferably 10 to 100 mPa·s and more preferably 10 to 50 mPa·s. Such low viscosity can be obtained by adding a suitable amount of an organic solvent. The viscosity can be also adjusted by keeping a coating solution at a set temperature.

On the other hand, when the viscosity of a resin layer formed after a solvent has vaporized is too low, a thickness of a lens may be hardly controlled when the resin layer is embossed with an emboss roller 13, which may not form a uniform lens with a fixed thickness. Preferred viscosity is 10 to 3,000 mPa·s. When a resin solution is mixed with the organic solvent, if a step of evaporating the organic solvent by heating and drying it is arranged between steps of supplying a resin solution and embossing the dried resin layer with the emboss roller 13, the mixture liquid can be uniformly supplied in a state having low viscosity, and the resin solution in a state of having increased viscosity by drying the organic solvent can be uniformly embossed with the emboss roller 13.

When a cured substance obtained by curing a resin solution according to the present invention with radiation is used for a prism lens sheet, it is particularly preferable for the substance to have physical properties (refractive index and softening point) as will be described below.

A refractive index at 25° C. of the cured substance is preferably 1.55 or higher, and further preferably 1.56 or higher. When the refractive index at 25° C. of the cured substance is less than 1.55, a prism lens sheet formed by using the present composition may not reliably develop sufficient front-face brightness.

A softening point is preferably 40° C. or higher and further preferably 50° C. or higher. This is because a cured substance having the softening point of less than 40° C. may not develop sufficient heat resistance.

In the next place, an action of an apparatus 10 for manufacturing an embossed sheet will be described with reference to FIG. 1 again. Sheet-like material feeding means 11 feeds a sheet W at a fixed rate. The sheet W is wound around a first suction drum 24, is absorbed and held by the drum, and is continuously transported. Subsequently, the sheet W is sent into a dust collector 28 which removes dust deposited on the surface of the sheet W.

Subsequently, the sheet W is sent into coating means 12 which applies a resin solution onto the surface of the sheet W. The coated sheet W is sent to drying means 19 which dries the applied resin solution on the sheet W by evaporating a solvent content. Thus, the manufacturing apparatus 10 has a step of drying a solvent included in a coating layer before winding the sheet W around an emboss roller 13 and curing the coating layer, so that the product has no fear of degrading its function and the strength of a cured film caused by the added solvent still remaining after having been cured. Similarly, the product has no fear of releasing a solvent while the product is used to produce a bad smell and adversely affect the health of people in the environment.

Subsequently, the sheet W is sent into forming means formed of an emboss roller 13 and a nip roller 14. Then, the rotating emboss roller 13 and nip roller 14 roll-form the continuously traveling sheet W, while pressing it at a position of 0° for the emboss roller 13. In other words, the rotating emboss roller 13 wind the sheet W around it, and transfers the pattern of concavities and convexities of the surface of the emboss roller 13 onto a resin layer.

Next, resin-curing means 15 irradiates a resin solution layer on the sheet W in the state of being wound around the emboss roller 13 with radiation. Then, the radiation passes through the sheet W to cure the resin solution layer. Afterwards, a release roller 16 releases the sheet W from the emboss roller 13 while winding the sheet W around the release roller 16 at a position of 180° for the emboss roller 13.

In the above step, the sheet W can be irradiated again with radiation in order to further promote curing after having been released from the emboss roller, though the device is not shown in FIG. 1.

A released sheet W is transported to defect inspection means 21 which inspects a defect of the pattern of concavities and convexities transferred and formed on the sheet W. By such defect inspection means 21, the defect of the pattern of concavities and convexities transferred and formed on the sheet W can be inspected, and a defective part can be easily eliminated.

Subsequently, the sheet W is transported to a dancer roller 30 which controls the tensile force of the sheet W by controlling a hoisting and lowering action of a traveling roller 30C installed between fixed rollers 30A and 30B. Because the dancer roller 30 (tension control means) controls the tensile force of the sheet W, the sheet W can move at a stable speed and has the pattern of concavities and convexities adequately transferred thereon.

Subsequently, a second suction drum 26 winds the sheet W around itself, absorbs and holds the sheet W thereon, and continuously moves it.

Subsequently, a sheet W is transported to edge position control means 32 which controls the position of the sheet W in a width direction. An embossed sheet according to the present invention has a fine pattern formed on the surface of the sheet, so that when the sheet deviates or varies while being transported, the deviation or variation sensitively leads to the production of a defect. However, the manufacturing apparatus can control the position of a sheet-like material in a width direction as described above, and can effectively prevent the above described defect from occurring.

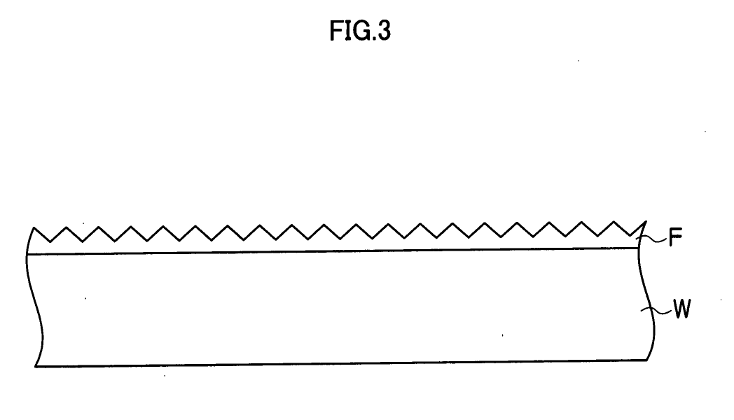

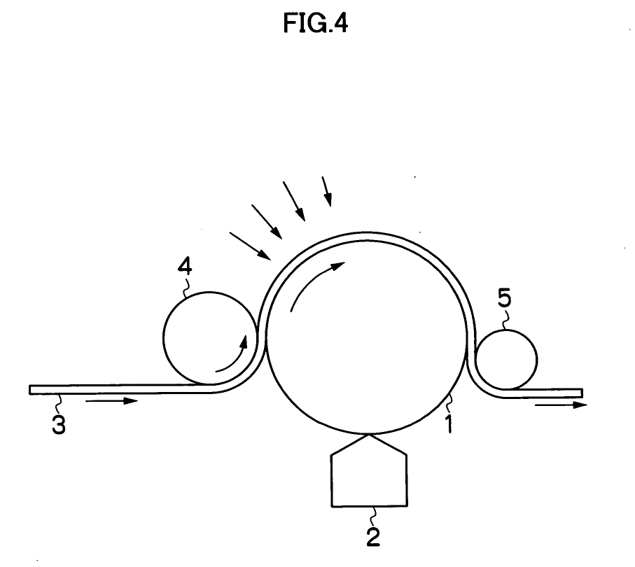

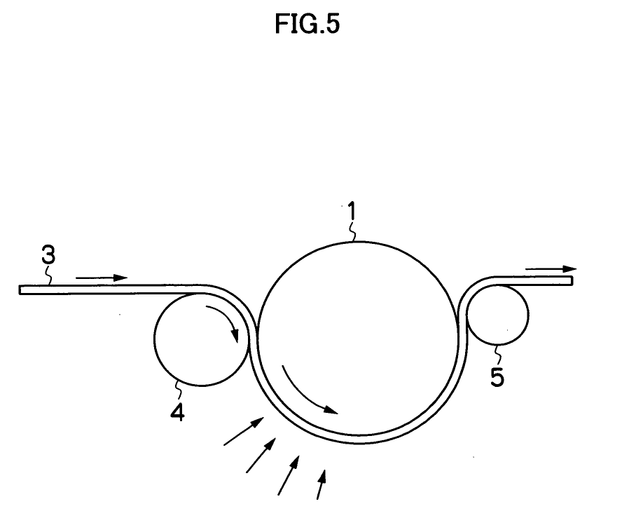

Subsequently, a sheet W is transported to sheet-winding means 18 which arranges a protective film H supplied from protective-film feeding means 17 on the surface of the sheet W, and wind overlapped both films around sheet-winding means to accommodate them. A diagrammatic cross-section shape of thus completed sheet W is shown in FIG. 3. The sheet W has a resin layer F on which the pattern of concavities and convexities on the surface of an emboss roller 13 are transferred formed on the surface.

Thus completed sheet W wound and accommodated by the winding roll can be cut into a product size in an offline after a series of steps. Such a completed sheet W is preferably used as an optical film.

A manufacturing apparatus having a series of steps from an upstream according to the above described present embodiment applies a radiation curable resin onto the surface of a continuously traveling sheet W; winds the sheet W around an emboss roller 13; irradiates a coating layer with radiation in a state of making the emboss roller transfer the pattern of concavities and convexities on its surface onto the coating layer to cure the embossed layer; releasing the sheet W from the emboss roller 13; laminating a protective film H on one or both surfaces of the sheet W; and winding them up into a rolled form. Accordingly, the manufacturing apparatus can wind up the sheet W in a series of the steps, and can manufacture the embossed sheet having high quality free from defects, at a high line speed with great productivity.

### Second Embodiment

In the next place, an embodiment according to the present invention will be described on the basis of the accompanying drawings. FIG. 1 is a view showing a configuration of an apparatus 10 for manufacturing an embossed sheet, to which the present invention is applied. A method and apparatus for manufacturing an embossed sheet according to a second embodiment has the same configuration as in the first embodiment and is particularly characterized by the configuration described below.

The surface of a nip roller 14 is preferably formed from a material having a rubber hardness of 40-80 degrees, which is specified in JIS K 6253. Such a nip roller 14 can appropriately sandwich/press a sheet W with/onto an emboss roller 13, and does not cause the slipping of the sheet W on the emboss roller 13.

The nip roller 14 rotates (free-runs) in a counter clockwise direction (CCW) as indicated by the arrow in FIG. 1.

It is preferable to install pressure-applying means to either of the emboss roller 13 and the nip roller 14 in order to apply predetermined pressing force between the emboss roller 13 and the nip roller 14. The pressing force is preferably 0.01 to 1.0 kgf/mm and further preferably 0.05 to 0.5 kgf/mm. When both rolls have such a range of sandwiching/pressing force, they can transfer the pattern of concavities and convexities adequately accurately onto the sheet W. Here, the sandwiching/pressing force is a value obtained by dividing applied force (kg) by the nip roller 14 by the width (mm) of the roller.

Similarly, it is preferable to install such fine adjustment means as to be able to precisely control a gap (clearance) between the emboss roller 13 and the nip roller 14, in either of the emboss roller 13 and the nip roller 14.

The surface of a release roller 16 is preferably formed from a material having a rubber hardness of 40-80 degrees, which is specified in JIS K 6253. Such a release roller 16 can appropriately sandwich/press a sheet W with/onto an emboss roller 13, and does not cause the slipping of the sheet W on the emboss roller 13.

It is preferable to install pressure-applying means to either of the emboss roller 13 or the release roller 16 in order to apply predetermined pressing force between the emboss roller 13 and the release roller 16. The pressing force is preferably 0.01 to 1.0 kgf/mm and further preferably 0.05 to 0.5 kgf/mm. When both rollers have such a range of sandwiching/pressing force, they can transfer the pattern of concavities and convexities adequately accurately onto the sheet W. Here, the sandwiching/pressing force is a value obtained by dividing applied force (kg) by the release roller 16 by the width (mm) of the roller.

Similarly, it is preferable to install such fine adjustment means as to be able to precisely control a gap (clearance) between the emboss roller 13 and the release roller 16, in either of the emboss roller 13 or the release roller 16.

A manufacturing apparatus according to the above described present embodiment releases a sheet W having the resin cured from an emboss roller 13 by winding the sheet W around a release roller 16, accordingly releases the sheet W in an adequate condition, and transfers the pattern of concavities and convexities adequately accurately onto the sheet W.

### Third Embodiment

In the next place, an embodiment according to the present invention will be described on the basis of the accompanying drawings. FIG. 1 is a view showing a configuration of an apparatus 10 for manufacturing an embossed sheet, to which the present invention is applied. A method and apparatus for manufacturing an embossed sheet according to a third embodiment has the same configuration as in the first embodiment, and is particularly characterized by the configuration described below.

A dust collector 28 and a cleaning device 22 among devices (means) shown in FIG. 1 correspond to a step of removing foreign substances from the surface of a sheet W (sheet-like material). The above dust collector 28 is one of dry type cleaning devices.

A usable cleaning device 22 includes a dry type and wet type cleaning device. Among them, the dry type cleaning device is the device for so-called dry cleaning, and includes, for instance, an inert gas type, a vapor type, a plasma type, an ultraviolet rays type and other types (such as adhesion roller type). The wet type cleaning device includes, for instance, a solvent type, a detergent type and an ultrapure water type.

Among dry cleaning devices, an inert gas type is well advanced in the removal of particles and is operated at a reduced running cost in particular; and includes, for instance, a device using argon fine particles at an ultra-low temperature.

Among dry cleaning devices, a vapor type is well advanced in cleaning capacity and is operated at a reduced running cost in particular; and includes, for instance, a device to be used in combination with wet type (wet) cleaning.

Among dry cleaning devices, a plasma type is well advanced in the removal of organic matters and is operated at a reduced running cost in particular; and includes, for instance, a device of a type not opening the inside to ambient pressure and a device of plasma cleaning in near ambient pressure.

Among dry cleaning devices, an ultraviolet rays type is well advanced in the removal of organic matters and is operated at a reduced running cost in particular; and includes, for instance, a device characterized by a wavelength of ultraviolet rays and a source and a device characterized by an atmospheric gas.

In the next place, means for removing contaminants in an apparatus 10 for manufacturing an embossed sheet will be described. Among the above means, the description on the above described dust collector 28 and the cleaning device 22 will be omitted.

The whole apparatus 10 for manufacturing an embossed sheet is arranged in a clean room having a cleanliness class of less than 5,000. Among the above devices, a cleaning device 22 and coating means 12 are further installed in a clean bench which is kept in a cleanliness class of less than 1,000. An embossed sheet having high quality free from defects and can be manufactured with great productivity, not only by keeping an atmosphere in an coating step at an adequate clean degree, but also by keeping the whole steps at an adequate clean degree, as described above.

In addition, a radiation curable resin is filtered with filtering means having pores with diameters of less than 10 μm, before being applied. Contaminants naturally contained in the radiation curable resin can be effectively removed by such filtering. The resin solution may be filtered before being supplied (applied) (online type), or may be filtered in another tank beforehand (offline type).

Among the previously described guide rollers G to G, which are members in a step of continuously traveling a sheet W, guide rollers G for guiding the sheet W while winding the sheet around guide rollers at a wrap angle less than 20° have drive means to equalize the peripheral velocity of each guide roller G to the traveling speed of the sheet W.

As described above, guide rollers G for guiding the sheet W while winding the sheet around guide rollers at a small wrap angle, for instance, guide rollers G to G in drying means 19 have each drive means to synchronize the peripheral velocity of each guide roller G with the traveling speed of the sheet W, and accordingly do not produce such contaminants as to originate in scraping for the sheet surface by slipping between the traveling sheet W and each guide roller G.

In addition, the apparatus 10 has a wall for enclosing a dust-generating site (such as motor) which is not illustrated into a sealed state in each step, controls the inside of the wall to a decompressed state by communicating it to suction means, and exhausts air sucked thereby to the outdoors. As described above, the dust-generating site is enclosed with the wall, is controlled into the decompression state, and consequently does not discharge dust and contaminants produced in the motor used for driving a roller into the atmosphere of each step.

The apparatus 10 arranges a dust collector 28 and a cleaning device 22 which are steps for removing foreign substances from the surface of a sheet W in particular, before the step of applying a radiation curable resin, introduces various measures for removing contaminants therein, consequently easily prevents fine contaminants (dust) from depositing on the sheet, and accordingly can manufacture an embossed sheet having a regular pattern of fine concavities and convexities formed on the surface and high quality free from defects, with great productivity.

In the above description, examples of embodiments on a method and an apparatus for manufacturing an embossed sheet according to the present invention were described, but the present invention is not limited to the examples of the above described embodiments, and can adopt various forms.

For instance, though the form of using a roller-shaped emboss roller 13 was adopted in an example of the present embodiment, the form of using a belt-shaped body such as an endless belt having a pattern of concavities and convexities (embossing shape) on the surface can be also adopted. This is because even such a belt-shaped body works similarly to a cylindrical roller and can provide a similar effect.

### EXAMPLES

In the next place, a third embodiment in the present invention will be described more specifically with reference to examples, but the present invention is not limited to these examples.

### Preparation of Resin Solution

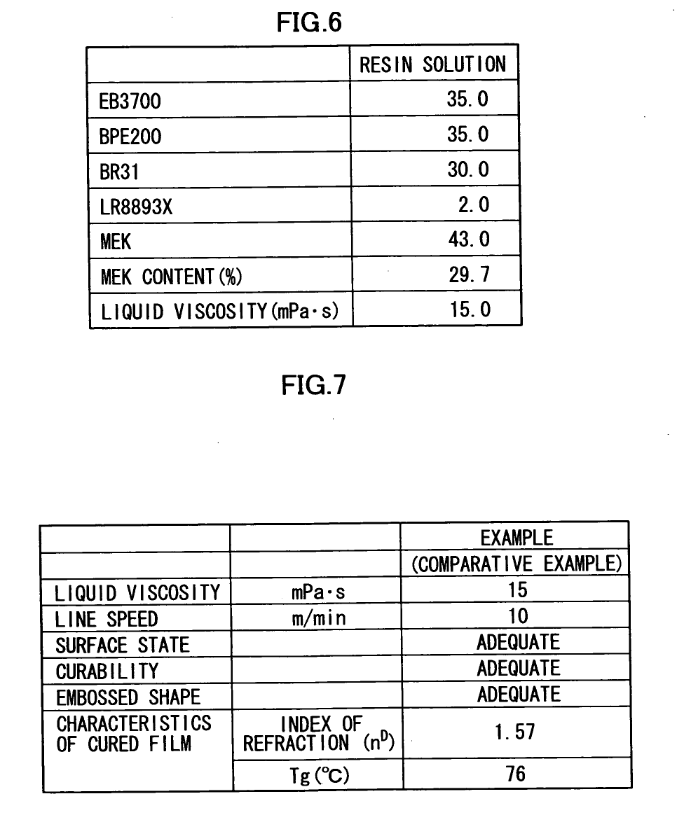

A resin solution was prepared by mixing compounds shown in Table of FIG. 6 at a described weight ratio, heating them to 50° C., and dissolving them while stirring them. Each name and content of the compounds described in the Table are shown below.

EB3700: Ubecryl 3700 manufactured by Daicel-UCB Company Ltd., bisphenol A type epoxy acrylate (with viscosity of 2,200 mPa·s/65° C.);

BPE200: NK Ester BPE-200 manufactured by Shin-nakamura Chemical Corporation, ethylene oxide added bisphenol A methacrylate (with viscosity of 590 mPa·s/25° C.);

BR-31: New Frontier BR-31 manufactured by Dai-ichi Kogyo Seiyaku industry Co., Ltd., tribromophenoxyethyl acrylate (solid at atmospheric temperature with melting point of 50° C. or higher);

LR8893X: Lucirin LR8893X, photoradical generator manufactured by BASF A.G., ethyl-2,4,6-trimethylbenzoylethoxyphenylosphine oxide; and

MEK: methyl ethyl ketone.

### Manufacture of Embossed Sheet

An embossed sheet was manufactured with the use of an apparatus 10 for manufacturing an embossed sheet having a configuration shown in FIG. 1.

A used sheet W was a transparent filn of PET (polyethylene terephthalate) having a width of 500 mm and a thickness of 100 μm.

An used emboss roller 13 had the length of 700 mm (width direction of sheet W) and the diameter of 300 mm, was made of S45C, and had a surface part made of nickel. Grooves with the pitch of 50 μm in a roller axial direction were formed on the whole circumference of the surface of a roller having a width of approximately 500 mm, by cutting the surface with a diamond turning tool (single point). A cross-sectional shape of the groove was a triangle shape having the apical angle of 90° at the top and the apical angle of 90° free from a flat part also at the bottom of the groove. Specifically, a groove width was 50 μm and a groove depth was about 25 μm. Because of having grooves free from joint lines and endless in a circumference direction of a roller, the emboss roller 13 can form a lenticular lens (prism sheet) having a triangular cross section on the sheet W. The roller has the surface plated with nickel after having had the groves formed thereon. A schematic cross-sectional view of the emboss roller 13 is shown in the previously described FIG. 2.

A die coater was used as coating means 12. An extrusion type coating head was used for the head 12C of the coating means 12.

Samples for each Example and Comparative Example were manufactured with the use of a liquid described in Table in the above described FIG. 6 as a coating solution F (resin solution).

The thickness of a coating solution F (resin solution) in a wet condition was controlled by adjusting an amount of the coating solution F supplied to a coating head 12C with a liquid-supplying device (liquid-supplying pump) 12B so that a film thickness after an organic solvent has been dried could be 20 μm.

A hot blast circulation type device was used for drying means 19. A temperature of a hot blast was set at 100° C.

A used nip roller 14 had a diameter of 200 mm, and had a surface layer formed of silicone rubber having a rubber hardness of 90. A nipping pressure (effective nipping pressure) of pressing a sheet W with an emboss roller 13 and the nip roller 14 was set at 0.5 Pa.

A metal halide lamp was used for resin-curing means 15 and irradiated the resin with light having the energy of 1,000 mJ/cm².

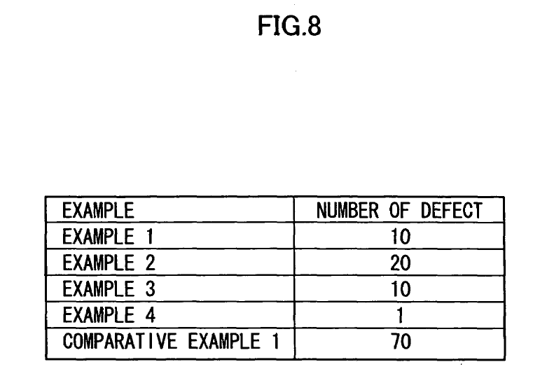

Through the above operations, a sheet W was obtained which had a pattern of concavities and convexities corresponding to each Example and Comparative example shown in Table of FIG. 8 which would be described later formed thereon.

### Evaluation for Embossed Shape

An embossed shape was evaluated by cutting the sheet W and measuring a pattern of concavities and convexities in the cross-sectional shapes at a plurality of points with the use of a SEM (scanning electron microscope). The diagrammatic cross-sectional shape of the sheet W (embossed sheet) is shown in previously described FIG. 3.

### Evaluation for Physical Property of Cured Film

An extra cured film was prepared by a method as is shown below and physical properties of the cured film were measured.

### Measurement of Refractive Index

A curable liquid composition was applied to a glass plate with the use of a spinner and was dried in an oven set at 100° C. for one minute. The film was irradiated with ultraviolet rays having the intensity of 1,000 mJ/cm² in a nitrogen atmosphere to be converted into a cured film. The refractive index of the cured film was measured at 25° C. with the use of an Abbe's refractometer.

### Measurement of Tg (Glass Transition Temperature)

A curable liquid composition was applied to a glass plate with the use of a spinner and was dried in an oven set at 100° C. for one minute. The film was irradiated with ultraviolet rays having the intensity of 1,000 mJ/cm² in a nitrogen atmosphere to be converted into a cured film with a film thickness of about 20 μm. The pendulum viscoelasticity of the cured film on the glass plate was measured with a pendulum type viscoelasticity-measuring instrument (model number: DDV-OPA manufactured by Orientec Co., Ltd.) at a heating rate of 5° C./minute, and Tg was determined to be a temperature at which a logarithm attenuation curve shows the maximum value.

A principle of pendulum viscoelasticity measurement is described in general books such as in the paragraph of “evaluation for viscoelasticity of polymer-based composite with rigid body pendulum type viscoelasticity device” in “collection of know-how on thermophysical property and thermal analysis of macromolecule” (first edition), edited by Gijutu Joho Kyokai Co., Ltd., P 287.

The result of a prepared embossed sheet is shown in Table of FIG. 7. In addition, a refractive index and Tg were measured according to the above described evaluation method. The result is also shown in Table of FIG. 7. According to Table of FIG. 7, Examples and Comparative examples showed no difference between them in the evaluation results of embossed shapes except the number of defects due to contaminants.

### Measure for Removing Contaminants and Evaluation Results Thereof

Samples for each Example (Examples 1 to 4) and Comparative example were prepared by using the apparatus having the previously described measure for removing contaminants taken as will be described below, in the above described conditions. The number of produced defects per 100 m² of the area of the prepared sheet W due to the contaminants was counted. The results are shown in Table of FIG. 8.

### Example 1

In an apparatus 10 for manufacturing an embossed sheet, a sticking roller was used as a cleaning device 22.

### Example 2

In an apparatus 10 for manufacturing an embossed sheet, devices for each step between sheet-like material feeding means 11 and a release roller 16 were kept at a cleanliness class of less than 1,000.

### Example 3

In an apparatus 10 for manufacturing an embossed sheet, devices for each step between sheet-like material feeding means 11 and a release roller 16 were kept at a cleanliness class of less than 100.

### Example 4

In an apparatus 10 for manufacturing an embossed sheet, devices for each step between sheet-like material feeding means 11 and a release roller 16 were kept at a cleanliness class of less than 100, and a sticking roller was used as a cleaning device 22.

### Comparative Example 1

Any measure for the removal of contaminants in Examples 1 to 4 was not taken.

As a result of the above described experiment, it was confirmed that an embossed sheet of high quality free from defects having a regular pattern of fine concavities and convexities free from the unevenness of a surface state formed on the surface can be manufactured with great productivity by taking each measure for removing contaminants, which is an effect of the present invention.

1-38. (canceled)

39. A method of producing an embossed sheet in which a pattern of concavities and convexities on a surface of an emboss roller are transferred and formed on a surface of a sheet-like material, comprising the steps of:
allowing a flexible strip-shaped sheet-like material to continuously travel;
forming a coating layer by coating the surface of the continuously traveling sheet-like material with a radiation curable resin;
transferring the pattern of concavities and convexities on the surface of the emboss roller to the coating layer by winding the continuously traveling sheet-like material around the rotating emboss roller;
curing the coating layer by irradiating the layer with radiation with the continuously traveling sheet-like material being wound around the emboss roller;
releasing the continuously traveling sheet-like material from the emboss roller;
laminating a protective film on one or both sides of the continuously traveling sheet-like material after releasing; and
taking up the continuously traveling sheet-like material after lamination in the form of a roll.

40. The method of producing an embossed sheet according to claim 39, wherein the pattern of concavities and convexities transferred and formed on he sheet-like material has a pitch of 100 or less.

41. The method of producing an embossed sheet according to claim 39, wherein the embossed sheet is used an optical film.

42. The method of producing an embossed sheet according to claim 39, further comprising a step of drying a solvent in the coating layer.

43. The method of producing an embossed sheet according to claim 39, further comprising a step of controlling a position of the sheet-like material in a width direction by detecting a position of an edge of the continuously traveling sheet-like material in the width direction.

44. The method of producing an embossed sheet according to claim 39 wherein the sheet-like material is allowed to continuously travel by a driving drum which holds the sheet-like material on an outer surface by sucking and rotates at a pre-determined peripheral speed.

45. The method of producing an embossed sheet according to claim 39, further comprising a step of controlling a tension of the continuously traveling sheet-like material by a tension control device.

46. The method of producing an embossed sheet according to claim 39, further comprising a step of cutting the sheet-like material taken up in a form of a roll into a product size.

47. The method of producing an embossed sheet according to claim 39, further comprising a step of inspecting a defect in the pattern of concavities and convexities transferred and formed on the sheet-like material.

48. The method of producing an embossed sheet according to claim 39, wherein the radiation is ultraviolet rays.

49. A method of producing an embossed sheet in which a pattern of concavities and convexities on a surface of an emboss roller are transferred and formed on a surface of a sheet-like material, comprising the steps of:
allowing a flexible strip-shaped sheet-like material on which a resin solution layer is formed by coating the sheet with a resin solution to continuously travel;
transferring the pattern of concavities and convexities on the surface of the emboss roller to the resin solution layer by winding the sheet-like material around the rotating emboss roller and pressing the sheet-like material by the emboss roller and a nip roller positioned against the emboss roller; and
curing the resin solution layer with the sheet-like material being wound around the emboss roller.

50. The method of producing an embossed sheet according to claim 49, wherein the pattern of concavities and convexities transferred and formed on the sheet-like material has a pitch of 100 mm or less.

51. The method of producing an embossed sheet according to claim 49, wherein the embossed sheet is used as an optical film.

52. The method of producing an embossed sheet according to claim 49, further comprising a step of releasing the sheet-like material after curing the resin solution layer from the emboss roller by winding the sheet-like material around a release roller positioned against the emboss roller.

53. The method of producing an embossed sheet according to claim 49, wherein
the emboss roller is provided between the nip roller and the release roller, and
the emboss roller is pressed by the nip roller and the release roller.

54. The method of producing an embossed sheet according to claim 49, wherein
the resin solution is a radiation curable resin solution, and
the resin solution layer is cured by irradiating the resin solution layer with radiation.

55. The method of producing an embossed sheet according to claim 49, wherein pressing is performed at 0.01 to 1.0 kgf/mm.

56. The method of producing an embossed sheet according to claim 49, wherein the surface of the nip roller and/or the release roller is formed from a material having a rubber hardness in accordance with JIS K 6253 of 40 to 80 degrees.

57. The method of producing an embossed sheet according to claim 49, further comprising a step of drying a solution in the resin solution layer.

58. The method of producing an embossed sheet according to claim 49, further comprising a step of controlling a position of the sheet-like material in a width direction by detecting a position of an edge of the continuously traveling sheet-like material in the width direction.

59. The method of producing an embossed sheet according to claim 49, wherein the sheet-like material is allowed to continuously travel by a driving drum which holds the sheet-like material on the outer surface by sucking and rotates at a pre-determined peripheral speed.

60. The method of producing an embossed sheet according to claim 49, further comprising a step of controlling the tension of the continuously traveling sheet-like material by a tension control device.

61. The method of producing an embossed sheet according to claim 49, further comprising a step of inspecting a defect in the pattern of concavities and convexities transferred and formed on the sheet-like material.

62. The method of producing an embossed sheet according to claim 54, wherein the radiation is ultraviolet lays.

63. A method of producing an embossed sheet in which a pattern of concavities and convexities on a surface of an emboss roller are transferred and formed on a surface of a sheet-like material, comprising the steps of:
allowing a flexible strip-shaped sheet-like material to continuously travel;
removing foreign substances from the surface of the continuously traveling sheet-like material;
forming a coating layer by coating with a radiation curable resin the surface of the continuously traveling sheet-like material from which foreign substances are removed;
transferring the pattern of concavities and convexities on the surface of the emboss roller to the coating layer by winding the continuously traveling sheet-like material around the rotating emboss roller;
curing the coating layer by irradiating the layer with radiation with the continuously traveling sheet-like material being wound around the emboss roller; and
releasing the continuously traveling sheet-like material from the emboss roller.

64. The method of producing an embossed sheet according to claim 63, wherein a dry or wet type cleaning device is used in the step of removing foreign substances from the surface of the sheet-like material.

65. The method of producing an embossed sheet according to claim 63, further comprising a step of filtering the radiation curable resin with a filtering device having a pore diameter of less than 10 μm before coating.

66. The method of producing an embossed sheet according to claim 63, wherein in the step of allowing the sheet-like material to continuously travel, the sheet-like material is held by a roller member, a driving device is provided on the roller member on which the sheet-like material is held at a wrap angle of less than 20 degrees and the peripheral speed of the roller member is brought in line with the traveling speed of the sheet-like material.

67. The method of producing an embossed sheet according to claim 63, wherein cleanliness in the step of forming a coating layer is kept at less than class 1000 and cleanliness in the respective steps is kept at less than class 5000.

68. The method of producing an embossed sheet according to claim 63, wherein in the respective steps, a dust-generating site is covered with a case and sealed and the pressure inside the case is reduced by a suction means communicated therewith.

69. The method of producing an embossed sheet according to claim 63, wherein the transferring is performed while pressing the sheet-like material by the emboss roller and a nip roller positioned against the emboss roller.

70. The method of producing an embossed sheet according to claim 63, further comprising a step of releasing the sheet-like material after curing the resin from the emboss roller by winding the sheet-like material around a release roller positioned against the emboss roller.

71. The method of producing an embossed sheet according to claim 63, further comprising a step of controlling a position of the sheet-like material in a width direction by detecting a position of an edge of the continuously traveling sheet-like material in the width direction.

72. The method of producing an embossed sheet according to claim 63, wherein the sheet-like material is allowed to continuously travel by a driving drum which holds the sheet-like material on an outer surface by sucking and rotates at a predetermined peripheral speed.

73. The method of producing an embossed sheet according to claim 63, further comprising a step of cutting the sheet-like material taken up in a form of a roll into a product size.

74. The method of producing an embossed sheet according to claim 63, further comprising a step of controlling a tension of the continuously traveling the sheet-like material by a tension control device.

75. The method of producing an embossed sheet according to claim 63, further comprising a step of inspecting a defect in the pattern of concavities and convexities transferred and formed on the sheet-like material.

76. The method of producing an embossed sheet according to claim 63, wherein the pattern of concavities and convexities transferred and formed on the sheet-like material has a pitch of 100 μm or less.

77. The method of producing an embossed sheet according to claim 63, wherein the embossed sheet is used as an optical film.

78. An apparatus for producing an embossed sheet, comprising:
a sheet-like material feeding device for feeding a flexible strip-shaped sheet-like material;
a coating device for coating the surface of the sheet-like material with a radiation curable resin to form a coating layer;
a drying device for drying a solvent contained in the coating layer;
a transferring device for transferring and forming a pattern of concavities and convexities on the surface of an emboss roller to the surface of the sheet-like material with the continuously traveling sheet-like material being wound around the rotating emboss roller;
a curing device for curing the coating layer with the sheet-like material being wound around the emboss roller;
a releasing device for releasing the sheet-like material from the emboss roller;
a laminating device for laminating a protective film on one or both sides of the sheet-like material after releasing; and
a sheet-like material take-up device for taking up the sheet-like material after lamination in the form of a roll.

79. An apparatus for producing an embossed sheet, comprising:
a sheet-like material feeding device for feeding a flexible strip-shaped sheet-like material;
a coating device coating the surface of the sheet-like material with a resin solution;
a transferring device for transferring and forming a pattern of concavities and convexities on the surface of an emboss roller to the resin solution layer by winding the sheet-like material around the rotating emboss roller and pressing the sheet-like material by the emboss roller and a nip roller positioned against the emboss roller;
a resin solution curing device for curing the resin solution with the sheet-like material being wound around the emboss roller; and
a releasing device for releasing the sheet-like material after curing the resin solution layer from the emboss roller by winding the sheet-like material around a release roller positioned against the emboss roller.

80. The apparatus for producing an embossed sheet according to claim 79, wherein the resin solution curing device is a radiation irradiation device provided near the emboss roller.
